(19) United States
(12) Patent Application Publication
(10) Pub. No.: US 2006/0065078 A1
(43) Pub. Date: Mar. 30, 2006

(54) Ratchet tool with easily removable C-shaped clip

(76) Inventors: Shih-Kun Chen, Taiping City (TW); Fu-Tsai Lee, Taiping City (TW)

Correspondence Address: Mr. Phillip LIU, 6980, Whiteoak Dr., Richmond, B.C., V7E 4Z9, CA

(21) Appl. No.: 10/950,825

(22) Filed: Sep. 28, 2004

(51) Int. Cl. B25B 13/46

(52) U.S. Cl. 81/60

(57) ABSTRACT

A ratchet tool includes an engaging member rotatably received in a hole in the head of the tool and a ratchet mechanism is received in a recess in the head. A lip extends inward from the inner periphery of the hole and the engaging member has a neck extending from one of two sides thereof. A C-shaped clip is connected to the neck. The neck includes an annular recessed plane and a second groove. A spring member is engaged with the annular recessed plane surface and has wave-shaped side profile which includes peak portions in opposite directions. The peak portions are respectively in contact with the lip and an inside of the recessed plane surface. The neck of the engaging member is pushed out from the hole when the spring member is compressed by pushing the engaging member.

### FIELD OF THE INVENTION

The present invention relates to a ratchet tool whose engaging member is biased by a wave-shaped ring which is compressed by pushing the engaging member and the C-shaped clip on the engaging member is easily removed.

### BACKGROUND OF THE INVENTION

A conventional ratchet tool generally includes head with a hole defined therethrough and a recess is defined in an inner periphery of the hole. A ratchet mechanism is received in the recess and includes a pawl, a bead and a spring which biases the bead which is engaged with a recess defined in a side of the pawl. An engaging member having toothed outer periphery is received in the hole and a toothed side of the pawl is engaged with the toothed outer periphery of the engaging member. A C-shaped clip is engaged with a groove defined in the inner periphery of the hole so as to retain the engaging member in the hole. However, the C-shaped clip is difficult to remove from the tool when the engaging member needs to maintain.

The present invention intends to provide a ratchet tool wherein the C-shaped is easily removed.

### SUMMARY OF THE INVENTION

The present invention relates to ratchet tool 10 A ratchet tool includes a head with a hole with a recess defined in an inner periphery of the hole so as to receive a ratchet mechanism therein. A lip extends inward from the inner periphery of the hole and a first groove is defined in the inner periphery of the hole. An engaging member is rotatably received in the hole and has toothed outer periphery with which the ratchet mechanism is engaged. The engaging member has a neck extending from one of two sides thereof. The neck includes an annular recessed plane and a second groove. A C-shaped clip is engaged with the first groove and the second groove. A spring member is engaged with the annular recessed plane surface and has wave-shaped side profile which includes peak portions in opposite directions. The peak portions are respectively in contact with the lip and an inside of the recessed plane surface. The neck of the engaging member is pushed out from the hole when the spring member is compressed by pushing the engaging member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet tool of the present invention;

FIG. 2 is a perspective view of the ratchet tool of the present invention;

FIG. 3 is a side cross sectional view to show the spring member biased between the lip and the engaging member;

FIG. 4 is a side cross sectional view to show that the neck of the engaging member is pushed out from the hole by pushing the engaging member and compressing the spring member, and FIG. 5 shows that a C-shaped clip is to be mounted to the neck of the engaging member.

### DETAILED DESCRIPTION OF THE PREFERRED EMBODIMENT

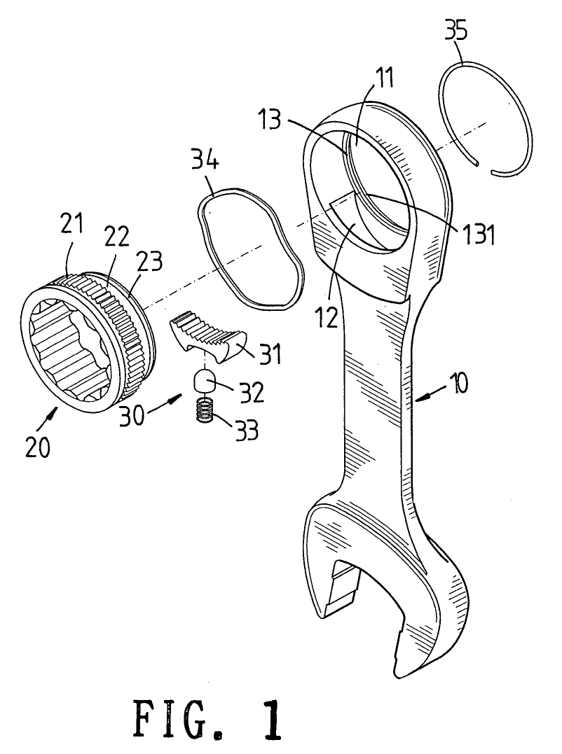

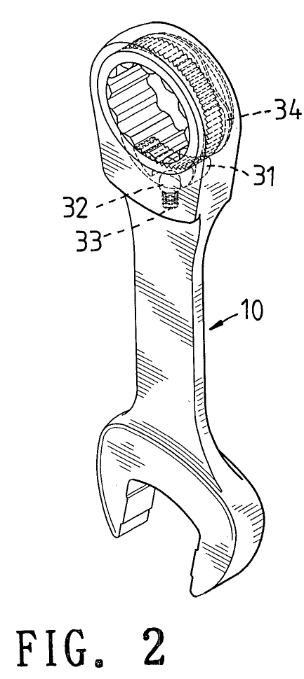

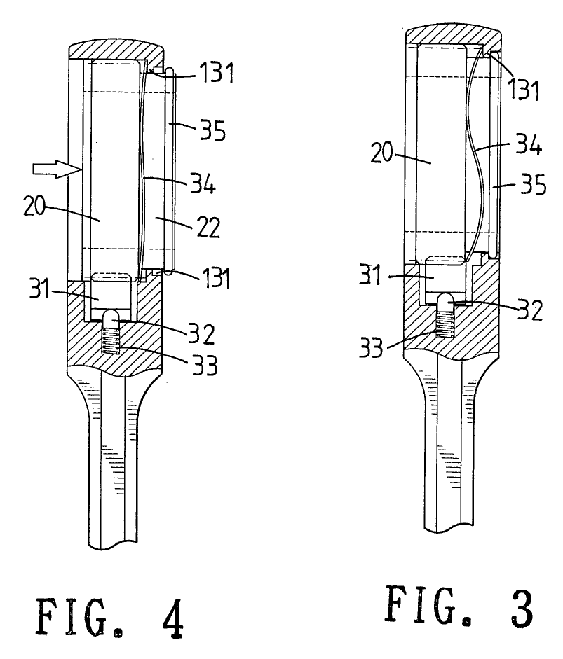

Referring to FIGS. 1 to 3, the ratchet tool 10 of the present invention comprises a head with a hole 11 defined therethrough and a recess 12 is defined in an inner periphery of the hole 11. A lip 13 extends inward from the inner periphery of the hole 11 and a first groove 131 is defined in the inner periphery of the hole 11. The first groove 131 is located on outside of the lip 13.

An engaging member 20 is rotatably received in the hole 11 and has a toothed outer periphery 21 and a polygonal inner periphery. A neck extends from one of two sides of the engaging member 20 and has an annular recessed plane surface 22. A second groove 23 is defined in the neck and a C-shaped clip 35 is engaged with the first groove 131 and the second groove 23.

A ratchet mechanism is received in the recess 12 and includes a pawl 31 with a toothed side and a notch defined in the other side opposite to the toothed side. A bead 32 is engaged with the notch and a spring 33 biases the bead 32. The toothed side of the pawl 31 is engaged with the toothed outer periphery 21 of the engaging member 20.

A spring member 34 is engaged with the annular recessed plane surface 22 and has a wave-shaped side profile which includes peak portions in opposite directions. The peak portions are respectively in contact with lip 13 and an inside of the recessed plane surface 22.

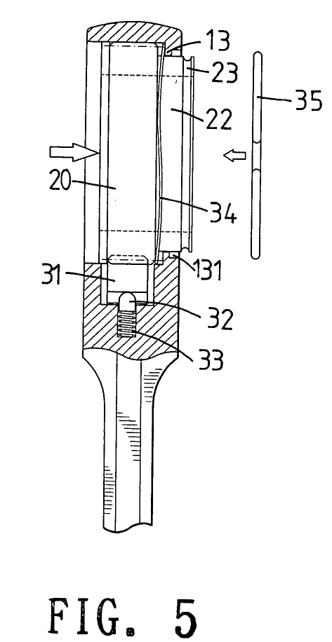

As shown in FIGS. 4 and 5, the user may push the engaging member 20 toward the spring member 34 which is then compressed and the neck of the engaging member 20 is pushed out from the hole 11. The C-shaped clip 35 is accessible conveniently and can be removed or installed when the engaging member 20 or the ratchet mechanism 30 are to be maintained.

The ratchet tool allows the users to conveniently access the parts in the head and includes a simple structure.

While we have shown and described the embodiment in accordance with the present invention, it should be clear to those skilled in the art that further embodiments may be made without departing from the scope of the present invention.

What is claimed is:

1. A ratchet tool comprising:
a head with a hole defined therethrough and a recess defined in an inner periphery of the hole, a lip extending inward from the inner periphery of the hole and a first groove defined in the inner periphery of the hole, the first groove located on outside of the lip, a ratchet mechanism received in the recess;
an engaging member rotatably received in the hole and having a toothed outer periphery with which the ratchet mechanism is engaged, a neck extending from one of two sides of the engaging member and having an annular recessed plane surface, a second groove defined in the neck and a C-shaped clip engaged with the first groove and the second groove, and
a spring member engaged with the annular recessed plane surface, the spring member having a wave-shaped side profile and including peak portions in opposite directions, the peak portions respectively contacting the lip and an inside of the recessed plane surface, the spring member capable of being compressed by pushing the engaging member and the neck of the engaging member being pushed out from the hole.

2. The ratchet tool as claimed in claim 1, wherein the ratchet mechanism includes a pawl with a toothed side and a notch defined in the other side opposite to the toothed side, a bead engaged with the notch and a spring biasing the bead.
